(19) United States
(12) Patent Application Publication
(10) Pub. No.: US 2012/0173995 A1
(43) Pub. Date: Jul. 5, 2012

(54) ELECTRONIC GATE FILTER

(75) Inventors: Rachid M. Alameh, Crystal Lake, IL (US); Robert A. Zurek, Antioch, IL (US)

(73) Assignee: MOTOROLA-MOBILITY, INC., Libertyville, IL (US)

(21) Appl. No.: 12/982,281

(22) Filed: Dec. 30, 2010

(51) Int. Cl. G06F 3/048

(52) U.S. Cl. 715/761; 715/769

(57) ABSTRACT

A method for selectively extracting information from a file and performing an operation corresponding to the extracted information includes selecting a data icon having information type; and moving the data icon towards a filter gate icon, in a single action, to initiate extraction. Metadata is extracted from the file associated with the data icon. The metadata comprises operational information used by a filter gate application to perform a function associated with the visual representation of the filter gate icon. Finally, the filter gate application is launched and populated with the extracted metadata from the file.

### FIELD OF INVENTION

The present invention is useful for user interfaces on a display screen. More specifically, the present invention simplifies a user's experience with a graphical user interface that includes functional choices.

### BACKGROUND

Electronic devices increasingly have more and more embedded functionality, hence making access to certain information time consuming for the average user. For example, a user may be reading a detailed document that has been emailed by someone else. In the case of many graphical user interfaces, the user has to scroll through the entire document to read the detailed information contained within the document, even though they may be several pages of information that may not be of interest to user. Due to time constraints placed upon the user, there are situations where the user needs to view certain aspects of the document instead of reading the entire document. One specific example can be when a user is reading a document and has an urgent question and wants to quickly contact the sender of the document without making the effort to locate the sender's phone number in another application or another device. The user may also prefer to refrain from typing a lengthy message to refer to document in question.

### BRIEF DESCRIPTION OF DRAWINGS

FIG. 1 illustrates a perspective view of tablet that includes gate filter icons;

FIG. 2 illustrates a view of user interface screen employing a drag & drop operation;

FIG. 3 illustrates a view of selected contact list;

FIG. 4 illustrates one exemplary contact selection;

FIG. 5 illustrates an exemplary android dialing screen for a selected contact;

FIG. 6 illustrates an exemplary flowchart for using a gate filter for a phone operation;

FIG. 7 illustrates a second view of a user interface screen employing a second drag & drop operation;

FIG. 8 illustrates an exemplary selection window displaying email recipients;

FIG. 9 illustrates an exemplary composition screen;

FIG. 10 illustrates an exemplary flowchart for using an email gate filter;

FIG. 11 illustrates a drag and drop operation employing an image gate filter;

FIG. 12 illustrates a gallery of displayed extracted images from the above image gate filter operation;

FIG. 13 illustrates an exemplary flowchart for an image extraction process; and

FIG. 14 illustrates an exemplary pictorial of sharing information across multiple screens.

### DETAILED DESCRIPTION

The present invention provides a simplified electronic gate scheme that filters information from documents and visually displays or passes relevant information that is contained within the document dependent on the gate filter characteristic. If the information is not contained within the document, the gate filter initiates a search within the device's stored memory or searches remote databases or social network sites to find the information. This combined filtering and data retrieval action is automated, but can be initiated with a single action of dragging the document toward the gate. It optimizes and simplifies a user's experience in operating a device and also enhances efficiency by using a single action to locate and display information of interest.

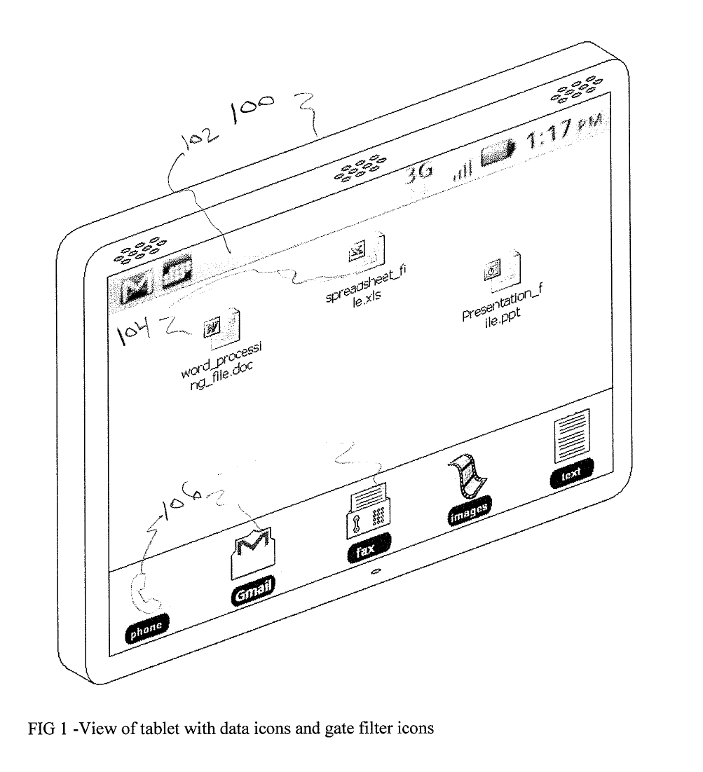

Referring to FIG. 1, an exemplary tablet 100 includes a graphical user interface that comprises a notification or status section 102. Data icons 104 are dispersed throughout the main body of the display screen. These data icons can be related to word processing, spreadsheets, and presentation applications, for example, but need not be limited to these applications alone. Accordingly, the data icons 104 can be associated with data files that include web documents, presentation documents, video, engineering documents, medical file formats, and audio, for example.

Also included in the graphical user interface of tablet 100 are several gate filter icons 106 that enable functional operations like phone or dialing operations, email operations, faxing operations, imaging operations, or texting operations, for example.

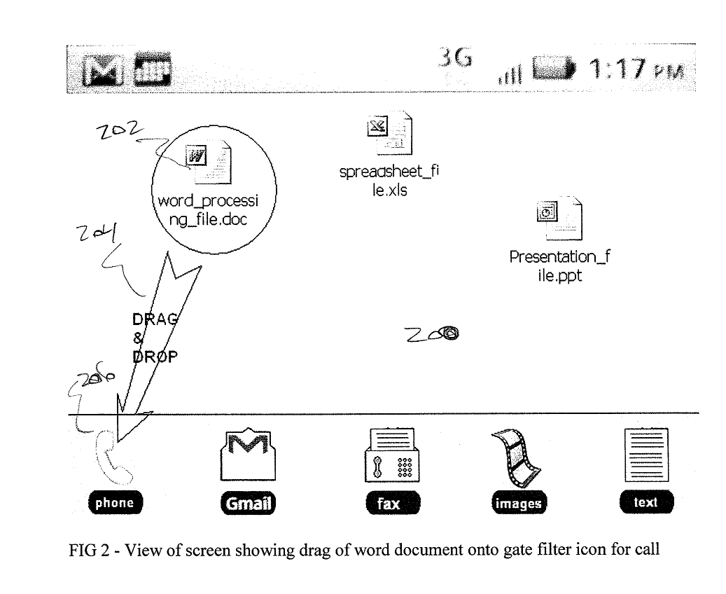

Referring to FIG. 2, an exemplary user interface 200 includes a data icon 202 being manipulated within a drag and drop operation 204 to terminate at gate filter 206. In this illustrated example, a word processing operation shown as data icon 202 includes one or more phone numbers or contacts within a document. Selection of data icon 202 includes information type such as word processing or presentation. The drag and drop operation 204 initiates the phone operation 206. Thus, moving the data icon towards a filter gate icon, in a single action, initiates an extraction operation. The phone operation 206 extracts phone numbers and or contact information from the document that was dragged and dropped.

Each of the gate filter icons 206 represents operations that extract the corresponding information from documents. Accordingly, the gate filter for phone extracts phone numbers, the gate filter for email extracts email addresses, the fax gate filter extracts fax numbers, the imaging gate filter extracts images, and the text gate filter extracts and displays only the text from the document.

The extraction process comprises extracting metadata from the file associated with the data icon. The metadata comprises operational information used by a filter gate application to perform a function associated with the visual representation of the filter gate icon; thereafter the filter gate application launched and populated with the extracted metadata from the file.

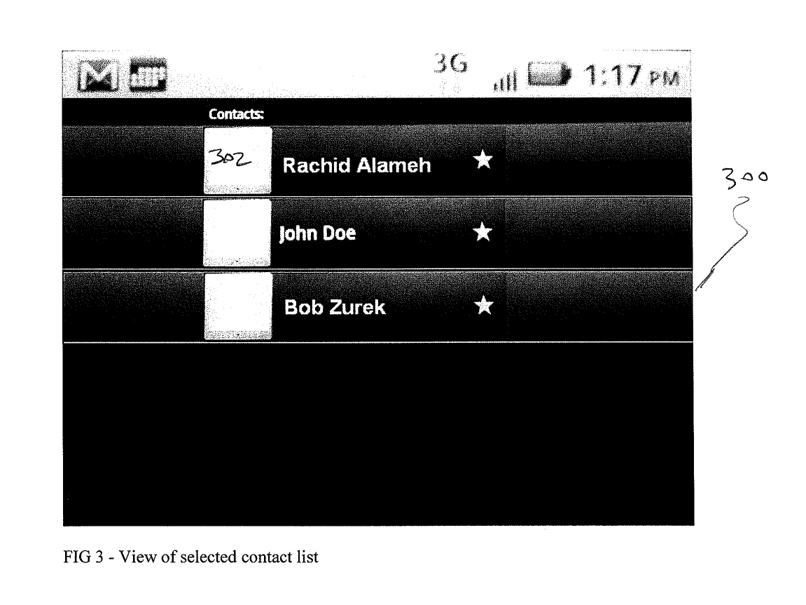

Referring to FIG. 3, a selected contact list 300 includes several contacts 302 which can be selected for individual information. Contacts 302 are extractable from the document and a user can select the person or number associated with contact 302. Contact list 300 is preferably created from contacts that already reside within the electronic device, such as a mobile phone or tablet. In this case, the phone information, name of the contact or both can exist in the document, or the missing information can be retrieved from local (internal) or external databases. For example, the name John Doe may exist in the data file that is being acted upon. The contact list in the electronic device has an entry for John Doe and can pass those numbers along to a phone dialer application on the electronic device.

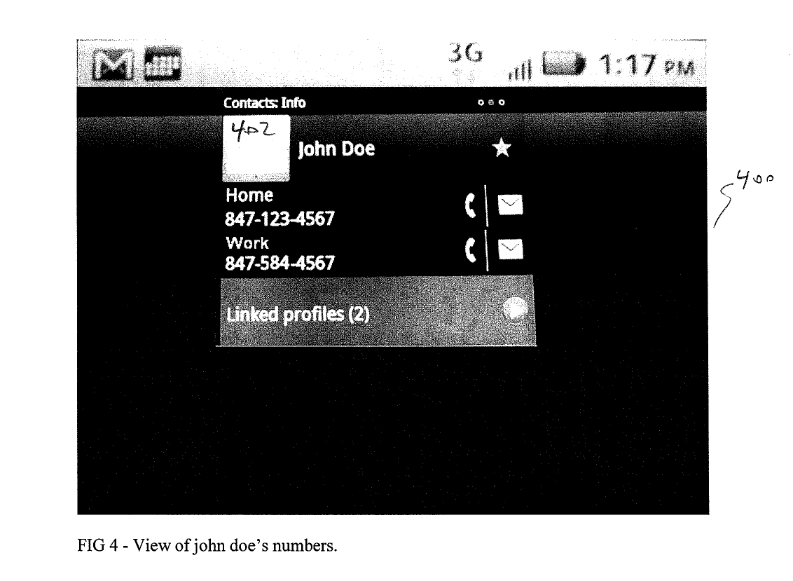

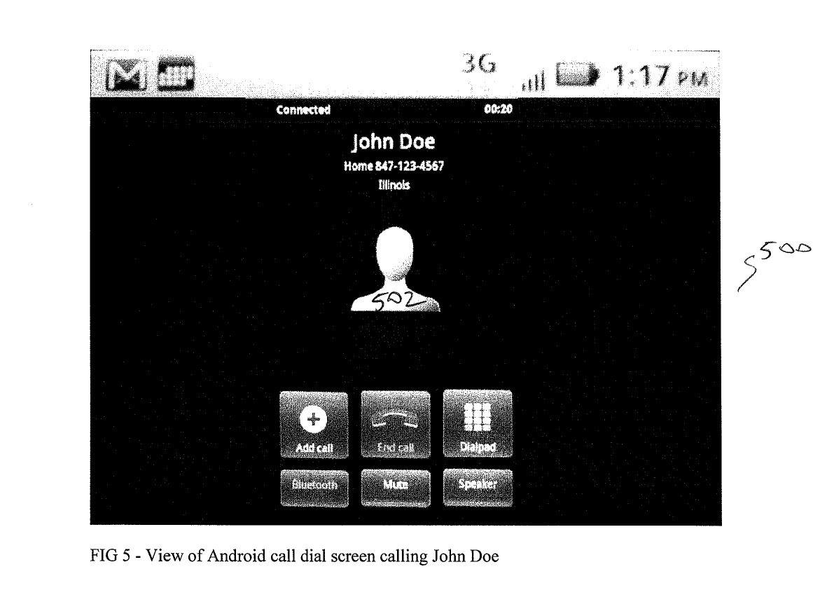

FIG. 4 illustrates where a single contact 400 with contact information 402 that includes multiple phone numbers was extracted from the document. In this example, only one person was listed in the document, hence only one person's contact information is displayed. The user can then select the appropriate number to dial from this screen. Accordingly, where there is a single number for a person the system can automatically display a dial screen for completion of a phone call as shown in FIG. 5. Dial screen 500 is displayed for contact 502 having a home phone number.

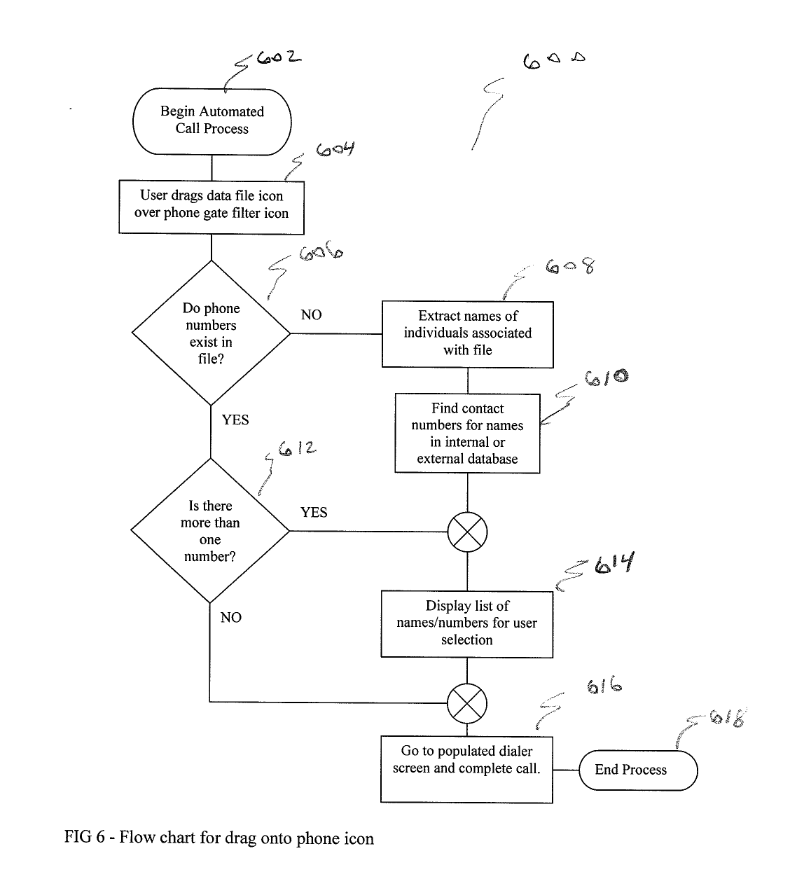

Flow chart 600 in FIG. 6 illustrates an exemplary drag and drop operation to extract information from a document that will be useful to initialize a phone call. This extracted information may be a phone number or a shorthand device or scheme for dialing a phone. Task 602 begins the automated call process. A user drags a data file icon over a phone gate filter icon. (Task 604) The data file icon and phone gate filter icon are both found in a display screen of an electronic device, such as a mobile phone or tablet. The user can implement a touchscreen using a finger or stylus or voice command.

A processor makes an inquiry of whether phone numbers exist in the document or file of interest for task 606. If the answer to the inquiry is negative, then task 608 extracts names of individuals associated with the document or file. Subsequently, task 610 finds contact numbers for the extracted names in either an internal or external database, including social networks that employ their own filters that are set by the user. Thus, another source other than the data file itself may be searched and information extracted therefrom. Additional extraction can come from an internal contacts list, organization contact lists, social networks, and Internet directory. The additional extraction data-sources and the order in which they are searched can be user selectable.

In the event that the inquiry in task 606 is positive, a further inquiry is performed by task 612 to inquire whether there is more than one number found in the document or file. If more than one number is found, then task 614 displays a list of corresponding names and numbers for selection by the user. If only a single number is found, then task 616 displays a populated dial screen of the single number and associated name of the person that will receive the phone call. Similarly, upon selection of a single name or number from the displayed list of task 614, task 616 displays a populated dial screen of the selected single number and associated name of the person that will receive the phone call and places the call. Task 618 ends the process.

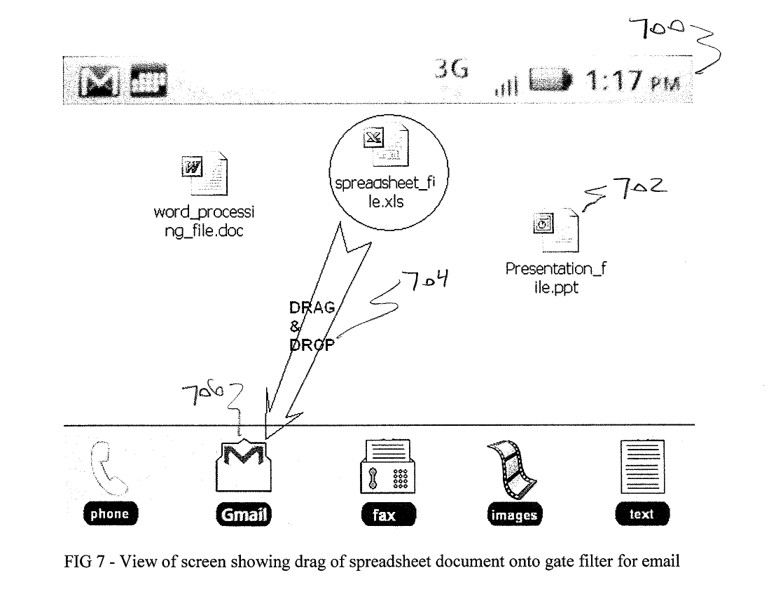

Referring to FIG. 7, a display screen 700 includes several data icons 702 (for example, presentation files, spreadsheet files, word processing files). At least one of the data icons 702 will be selected and employed in a drag and drop operation 704. In FIG. 7, spreadsheet file data icon 702 is dragged and dropped upon email gate filter 706. Accordingly, this operation initiates the extracting of email addresses of individuals and entities from the spreadsheet document or file. Search algorithms are employed on internal and external databases to extract email addresses for names of individuals or entities in the event that the spreadsheet document or file does not include an email address for the individual or entity.

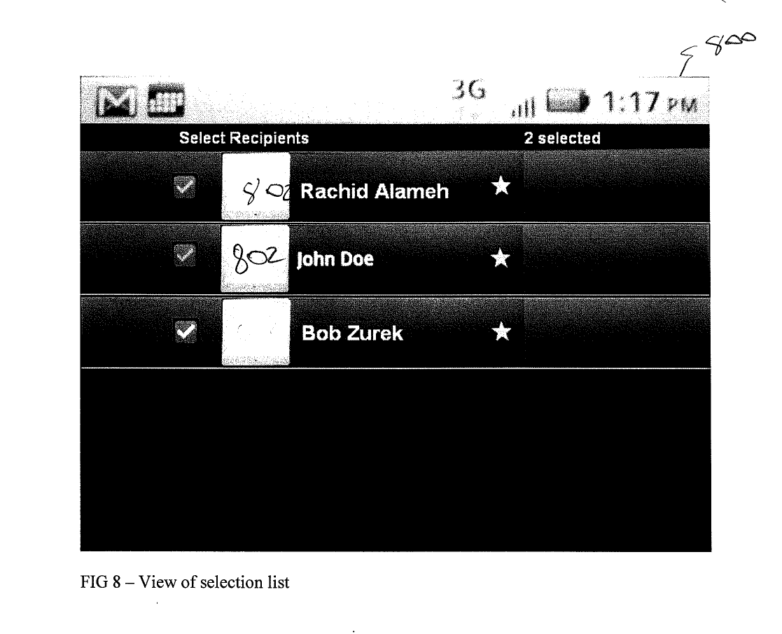

Referring to FIG. 8, an exemplary email selection window 800 enables a user to select individuals, entities, singular or several as email recipients 802. Email recipients 802 are extractable from the document or file and a user can select the email address associated with email recipient 802. Selection list 800 is preferably created from email recipients that already reside within the electronic device, such as a mobile phone or tablet. However, an external database may provide email recipients as well.

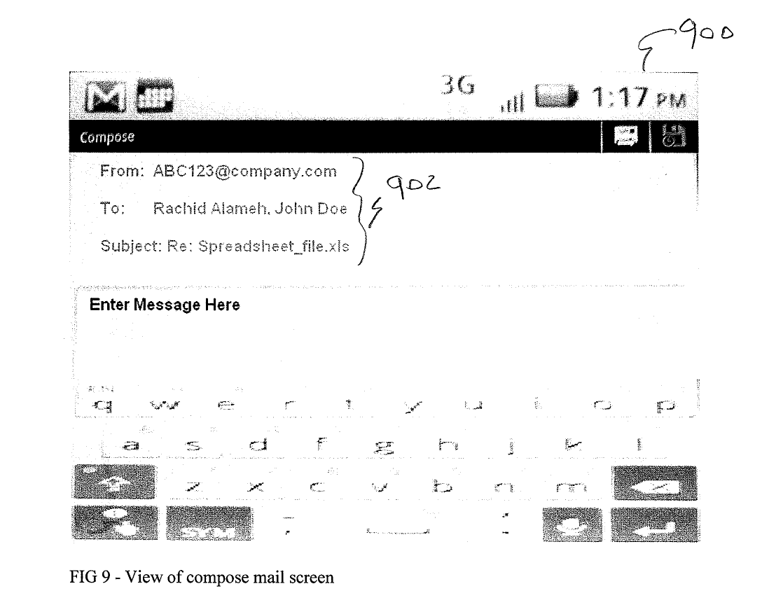

Referring to FIG. 9, an exemplary composition mail screen 900 is shown. The composition mail screen 900 displays an email list that includes addressees and addressers (also referred to as “to” and “from” parties) and email subject information within composition block 902. The “to”, “from”, and email subject information can be automatically generated by the filtering operation.

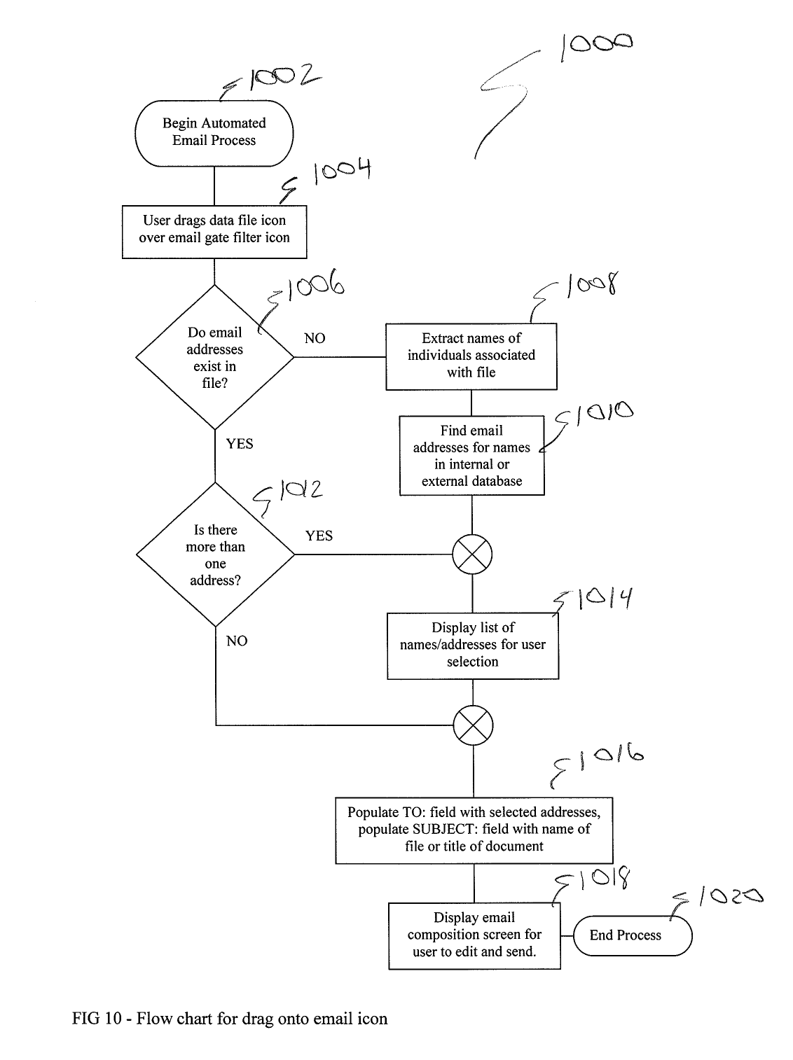

Flowchart 1000 in FIG. 10 illustrates an exemplary drag and drop operation to extract information from a document or file that will be useful to initialize drafting an email. This extracted information may be an email address or a shorthand device or scheme for composing or drafting an email. Task 1002 begins an automated email process. In task 1004, a user drags a data file icon over an email gate filter icon. The data file icon and email gate filter icon are both found in a display screen of an electronic device, such as a mobile phone or tablet. The user can implement a touchscreen using a finger or stylus or voice command.

A processor makes an inquiry in task 1006 of whether email addresses exist in a file or document. If the answer to the inquiry is negative, task 1008 extracts names of individuals associated with the file or document. Task 1010 finds email addresses for names within an internal or external database.

Should email addresses actually exist in the document or file, a second inquiry is performed by task 1012 to inquire whether there is more than one email address. Task 1012 is also performed upon a finding of email address within an internal or external database. Should the inquiry in task 1012 be deemed negative, that is that are no multiple email addresses, then task 1016 begins populating a composition block that includes a “TO” line, a “FROM” line, and a “SUBJECT” line. The “TO” line and “FROM” line includes a field for selected email addresses. The “SUBJECT” line includes a field with the name of a file or title of a document.

Should the inquiry in task 1012 be deemed positive, that is that are multiple email addresses, then task 1014 displays a list of names and email addresses for selection by a user prior to the population operation of task 1016 described above. Subsequent to task 1016, an email composition screen is displayed by task 1018 that enables a user to edit and send a composed or drafted email. Task 1020 ends the automated email process.

Short messaging applications (SMS) and faxing operations can be initiated similarly to the aforementioned email operation. One exception for the faxing operation will be the inclusion of a header page that comprises an automatically generated title and a field for a user to enter a comment or description.

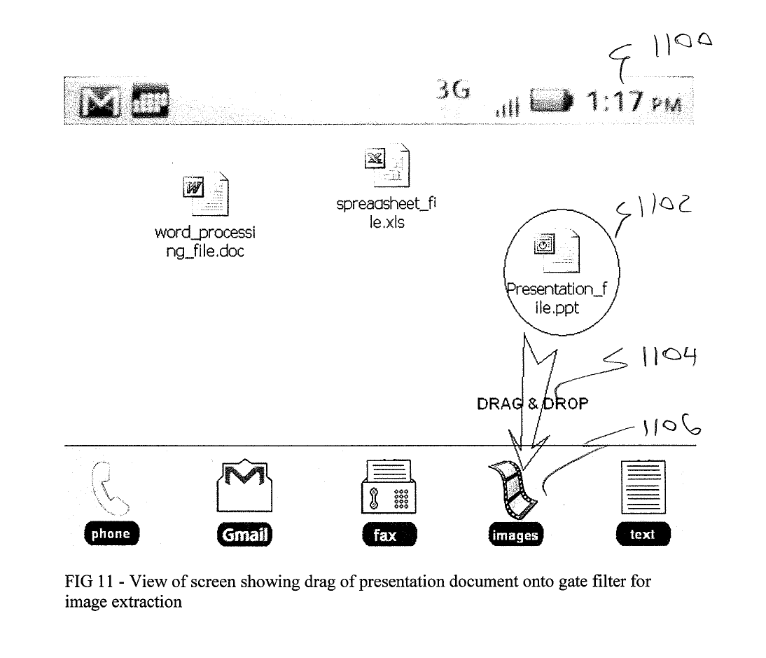

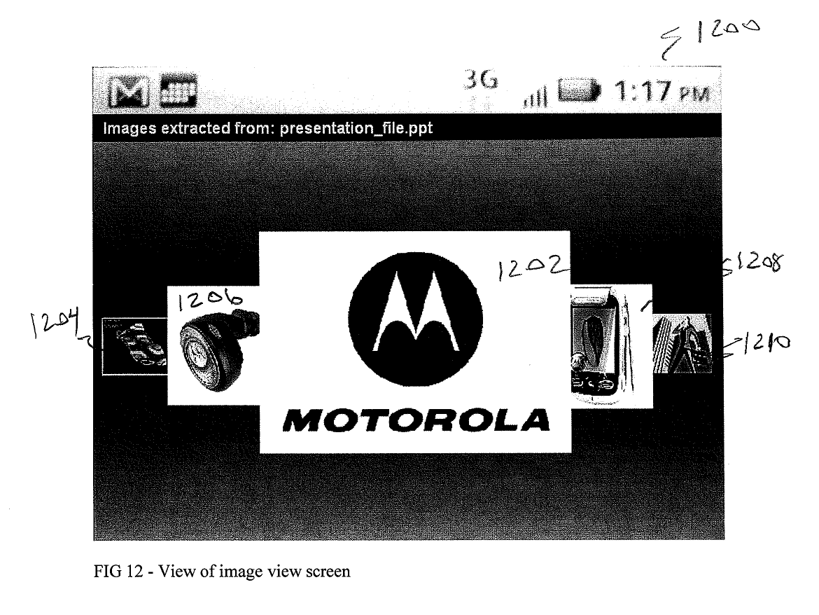

Referring to FIG. 11, a display screen 1100 includes several data icons 1102 that can be selected for a drag and drop operation 1104. In this example, a presentation data icon 1102 is dragged and dropped onto an image extraction gate filter 1106. Therein, images or pictures within the presentation document or file can be extracted. For example, in FIG. 12, a display screen 1200 displays extracted image 1202 for viewing. Extracted image 1202 was extracted from a presentation file. The viewable extracted images can make up a gallery as shown in FIG. 12 images 1202-1210.

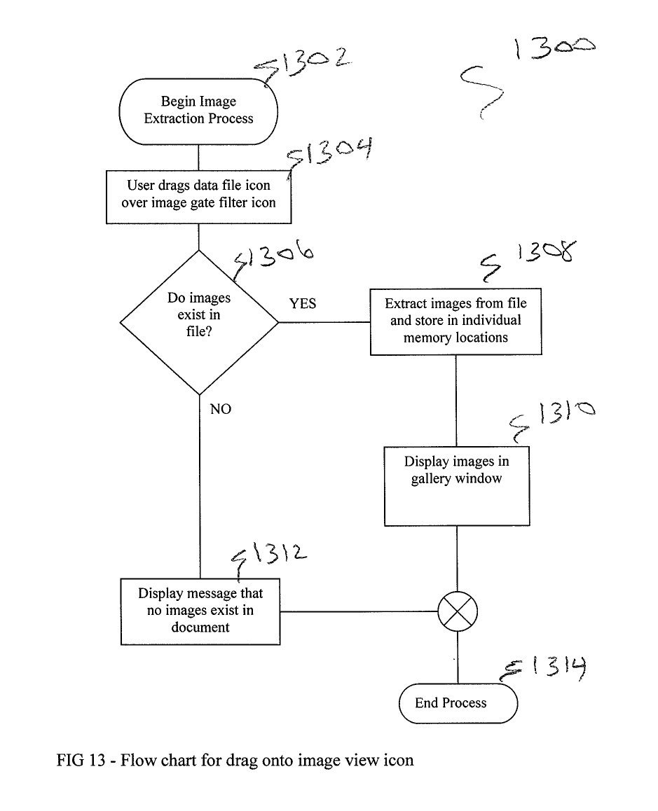

Flowchart 1300 shown in FIG. 13, illustrates an exemplary process for extracting embedded images or pictures in a file or document. The exemplary process extracts information from a document or file that will be useful to initialize an image display operation for a gallery, for example. This extracted information may be an image, picture (still or motion) or a shorthand device or scheme for displaying an image. Task 1302 begins the image extraction process. In task 1304, a user a drags data file icon over an image gate filter icon. The image filter gate icon represents image formats comprising JPEG, MPEG, GIFF, TIFF, raw, PDF, and bitmap. The data file icon and image gate filter icons are both found in a display screen of an electronic device, such as a mobile phone or tablet. The user can implement a touchscreen using a finger or stylus or voice command.

An inquiry by task 106 inquires whether any images exist in associated document or file that was dragged and dropped over the image gate filter icon. If an image exists, task 1308 extracts the one or more images from the file or document and stores the one or more images in one or more memory locations. Thereafter, task 1310 displays images in a gallery window that is viewable to the user.

In the event that no images exist in the document or file, task 1312 displays a message that no images exist in the file or document. Task 1314 ends the image extraction process.

It should be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in a figure could be omitted from an embodiment of the respective process as long as the intended overall functionality remains intact. In this vein, a text extraction process will operate similarly to the processes described above. The text extraction operation would extract only text from a data file that is acted upon by the gating filter and display the text contained in the file to the user.

Another embodiment may employ a data security filter gate icon that comprises encryption and selective filtering of sensitive information. In this vein, a user might want to share his electronic device with others, but have sensitive information on the electronic device. Prior to sharing the electronic device with another user, the owner user drags the document into a one of a number of data security associated filter icons. For example, a financial data security gate filter can look for symbols such as a “$”, or the reoccurring words “money”, “credit”, or “cash” or even raw financial data. The financial data security gate filter would then perform an operation to either remove from the document or make invisible the sensitive information in the document. Another embodiment can employ a data security gate filter that looks for key word match such as checking, saving, Visa™, American Express™, money, payment, account, account number and either remove from the document or make invisible the sensitive information in the document. Another embodiment provides a data security gate filter that encrypts the entire document, hence making it not openable or viewable without entering a security code or dragging the document onto another gate filter icon that the user has set as his “security nullification” icon. Sensitive information can be defined as financial information, work information, confidential information, privileged information (such as a teacher-student privilege).

In another embodiment, a user sets a search location order preference (according to his needs or likes) for extraction of information (e.g., first local document, then home emails, then work email, then facebook, etc).

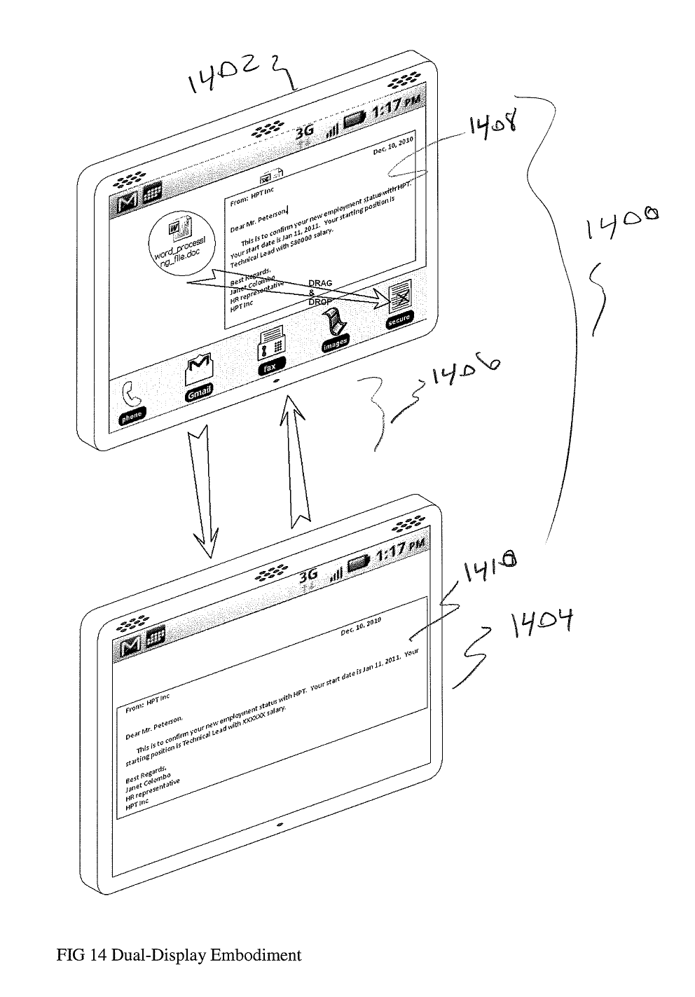

Another embodiment utilizes one or more display screens that may operate independently, but can be paired together to enact the drag and drop operation. That is for two separate screens—one displays the icons being acted upon and the other screen displays the result of the gate filter action as shown in FIG. 14. These two screens could be on two different electronic devices.

Referring to FIG. 14, a dual display embodiment 1400 is shown that includes display screen 1402 and display screen 1404 that are wireless paired via communicative coupling 1406, such as Bluetooth™ or infrared or other like communicative coupling techniques. A word processing document 1408 contains salary information for an employment offer in its non-filtered form. Upon dragging and dropping the word processing document 1408 onto a secure gate filter icon, the salary information is stripped away and results in word processing document 1410.

Accordingly, a first screen that displays the data and gate filter icons can be thought of as a controller screen. Therein, the first screen can display an original, unfiltered version of the document or file. A second screen displaying the outcome of the gate filter action can be thought of as an output or action display screen. Therein, the second screen displays a filtered version of the document or file as described above, which can include data security filtering and encryption. Consequently, one user can feel confident when transferring or sharing documents between multiple electronic devices that may be owned by other users.

One example could be in a classroom setting where a teacher shares part of his document, on one electronic device having a controller screen, with multiple students, who have paired electronic devices that have action display screens (i.e., devices communicatively coupled) during an exam preparation setting. The teacher's document on the controller screen can be ‘dragged’ through a gate filter which passes a test document to the students without passing the test answers (the test answers are filtered out by the specific filter gate) before the document is transmitted wirelessly to the student's paired devices with action display screens. These paired electronic devices may or may not be in close proximity to the controller screen. Alternatively, a teacher might decide to pass a document without his personal notes or comments to the students. The gate filter in this case strips out any text that is recognized as hand written or text grouped under a specific section or tagged in a certain way.

Another example is a parent wanting to remove certain bad language in a movie or song playing on a device, therefore passing to her child a clean version that filters out or substitutes preferable so-called ‘good’ words before it is transmitted to the child's paired device or before it is played again on the main device.

Another example is a parent wants to select the right rating for a movie to share with a minor. Parent passes the movie file through a filter that selects the right MPAA rating allowing a child to view a safer version suitable for his age.

Another example is in gaming allowing user to select a game's complexity. User drags the game icon through a low complexity filter to select a simpler game version more suitable to the intended recipient age, comprehension, and ability. A game application could have an adult level and a kid's level of complexity, appearance, sound, etc.

Another example is a gate filter to assist those with special need which alters a document's content (visual or audible, or other effects) to assists users with disabilities and certain medical needs allowing them to more easily read and interact with the document.

Another example is a gate filter that makes a document read only and disables any editing or changes capabilities to prevent unintended changes while viewed by others, etc.

Other embodiments can employ several different methods (other than dragging and dropping the data icon onto the gate filter icon) for selecting the data icon and moving the data icon to the gate filter icon. These methods include, but are not exhaustive, voice command, touching data icon and gate filter icon simultaneously, touching data icon and gate filter icon sequentially, and touching data icon and gate filter icon within a specified time period.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

We claim:

1. A method for selectively extracting information from a file and performing an operation corresponding to the extracted information, comprising the steps of:
selecting a data icon that includes information type;
moving the data icon towards a gate filter icon, in a single action, to initiate extraction;
extracting metadata from the file associated with the data icon, said metadata comprises operational information used by a gate filter application to perform a function associated with the visual representation of the gate filter icon; and
launching the gate filter application populated with the extracted metadata from the file.

2. The method claimed in claim 1, wherein the data icon represents a data file not specifically associated with the function of the filter gate icon.

3. The method claimed in claim 1, further comprising additional extraction from another source other than the data file.

4. The method claimed in claim 3, wherein the additional extraction comes from an internal contacts list, organization contact lists, social networks, and Internet directory.

5. The method claimed in claim 3, wherein the additional extraction is user selectable.

6. A system for selectively extracting information from a file and performing an operation corresponding to the extracted information, comprising:
a displayed user interface;
a data icon associated with a data file, wherein the data icon is within the user interface;
a plurality of gate filter icons within the user interface; and
a processor for extracting metadata from the data file and launching the gate filter application populated with the extracted metadata from the file, wherein the data file isn't specifically associated with the plurality of gate filter icons.

7. The system claimed in claim 6, wherein the data file is selected from the group consisting of spreadsheets, word processing, image document, web document, presentation document, video, engineering documents, medical file format, audio.

8. The system claimed in claim 6, wherein the gate filter icon represents communication information comprising phone, email, short messaging, facsimile.

9. The system claimed in claim 6, wherein the gate filter icon represents data security comprising encryption and selective filtering.

10. The system claimed in claim 6, wherein the gate filter icon represents image formats comprising JPEG, MPEG, GIFF, TIFF, raw, PDF, and bitmap.

11. The system claimed in claim 1, wherein the step of moving the data icon towards a gate filter icon is implemented across multiple independent display screens.

12. The system claimed in claim 4 wherein the additional extraction is preferentially selectable by a user.

13. The system claimed in claim 1, wherein the steps of selecting a data icon that includes information type; and moving the data icon towards a gate filter icon, in a single action, to initiate extraction is selected from the group consisting of: dragging and dropping, voice command, touching data icon and gate filter icon simultaneously, touching data icon and gate filter icon sequentially, and touching data icon and gate filter icon within a specified time period.

14. A non-transitory machine readable storage, having stored thereon a computer program having a plurality of code sections comprising:
a code for selecting a data icon that includes information type;
a code for moving the data icon towards a gate filter icon, in a single action, to initiate extraction;
a code for extracting metadata from the file associated with the data icon, said metadata comprises operational information used by a gate filter application to perform a function associated with the visual representation of the gate filter icon; and
a code for launching the gate filter application populated with the extracted metadata from the file.
